(19) United States
(12) Patent Application Publication
(10) Pub. No.: US 2010/0307974 A1
(43) Pub. Date: Dec. 9, 2010

(54) PREPARATION AND USE OF NOVEL POLYANILINES FOR WATER TREATMENT

(75) Inventors: Karl-Heinz Pettinger, Garching (DE); Franz-Xaver Muller, St. Wolfgang (DE); Gerhard Illing, Emden (DE); Mathias Ulbricht, Berlin (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 12/743,620

(22) PCT Filed: Nov. 20, 2008
(86) PCT No.: PCT/EP2008/065909

§ 371 Date: Aug. 26, 2010

(30) Foreign Application Priority Data
Nov. 23, 2007 (DE) 10 2007 056 423.8

(51) Int. Cl. C08G 75/04; C08L 81/00; B32B 5/02; B32B 1/00; B32B 27/00; B05D 3/02; B01D 53/22; B03C 3/40; B01D 53/02; B01D 71/76; B01D 69/08; B01D 15/04; B03C 5/02; C02F 1/44

(52) U.S. Cl. 210/650; 528/374; 524/609; 442/59; 442/1; 428/35.7; 428/704; 428/688; 427/385.5; 96/13; 96/10; 96/15; 96/153; 210/490; 210/500.23; 204/660; 210/263; 204/665; 95/45

(57) ABSTRACT

The invention relates to a polyaniline, comprising aniline units and organosulphur units, characterized in that the polyaniline is doped and has a number average degree of polymerization of approximately 5 to approximately 50. The scope of the invention also includes a process for the preparation of polyaniline, wherein aniline and at least one organosulphur unit are converted to a polyaniline derivative in an oxidative, acid-catalyzed polymerization reaction. A subject of the invention is also a coated substrate which is coated with the polyaniline according to the invention and also a process for the coating of the substrate. The scope of the invention furthermore also includes a coating composition which is suitable for the coating of the substrate. The invention thus also relates to a process for the preparation of the coating composition. A subject of the invention is also the use of polyaniline which is doped and has sulphur in the main polymer chain for water treatment and/or for the purification of air and also a purification reactor for carrying out the purification process.

### FIELD OF THE INVENTION

The invention relates to polyaniline derivatives with organosulphur units and also the use of the polyaniline derivatives in water conditioning, for the purification of air, for the preparation of redox flow batteries or in electrolysis. The invention also relates to a process for the preparation of the novel polyaniline derivatives and substrates coated with the polyaniline derivatives.

### STATE OF THE ART

In water conditioning, oxidative processes are frequently used for the reduction of noxious substances and disinfection. Wet-chemical processes involving the addition of chemicals lead in many cases to an unwanted increase in salinity of the waters and require activation by UV radiation or electrochemical steps.

These so-called “Advanced Oxidation Processes” generate OH radicals which then have an oxidative effect on the impurities. For example, polyaniline produces active oxygen species, such as for example OH radicals, superoxide radical anions and similar, from the oxygen dissolved in the water and can be electrochemically regenerated.

Polymers which conduct electric current without the addition of conductive, inorganic substances are called “intrinsically conductive polymers” (ICPs). The particular properties of ICPs lie in their polyanionic structure and their specific morphology.

Polyaniline (PAni) also belongs to the group of ICPs. The synthesis of polyaniline takes place via radical (Min-Jong Chang, Yun-Hsin Liao, Allan S. Myerson, T. K. Kwei, J. Appl. Pol. Sci., Vol. 62, 1427-1428) or electrochemical polymerization from acid solution (B. J. Hwang, R. Santhanam, C. R. Wu, and Y. W. Tsai. J. Solid State Electrochem., 5:280-286, 2001).

To date, polyaniline has been used predominantly as corrosion protection, in electronics (conductive layer in flexible PCBs and displays), for EMI shielding, or as antistatic component.

In the literature, polyaniline is also described for water treatment (see e.g. EP 0 782 970 B1). Polyaniline can for example be used as granular material and the treatment of water take place in packed beds.

However, in most cases an effective water conditioning also requires a filtration of the water to be purified, e.g. by ultrafiltration via membranes.

Membranes in which a catalytic activity is combined directly with a specific barrier structure (catalytic membranes) are of particularly great interest in process intensification. This can be achieved by embedding a catalyst in the volume of the membrane material or by immobilization at the outer or inner membrane surface. An example of the latter variant is the catalytic detoxification of an aqueous stream (degradation of chlorinated hydrocarbons) through a porous membrane made of cellulose acetate with immobilized Fe/Ni nanoparticles (Meyer D. E., Wood K., Bachas L. G., Bhattacharyya D., Environmental Progress 2004; 23:232-242).

Latterly polyanilines on membranes have also been discussed for possible uses in water conditioning. Thus for example JP 2003-159596, in which membranes coated with polyaniline for the elimination of microorganisms by active oxygen is described.

The use of membranes in the field of water conditioning has increased rapidly. With this technology, however, problems occur with scaling, fouling and mechanical loading. The result is that disinfection steps are often also required after membrane filtration. Scaling and fouling lead to reduced service lives, and also significant costs for cleaning and spare parts. (N. Engelhardt, H. Heidermann, K. Drensla, C. Brepols, A. Janot, Optimierung einer Belebungsanlage mit Membranfiltration, Erftverband, Bereich Abwassertechnik, Bergheim, October 2004).

A further problem occurs with membrane coatings. These often display inhomogeneities which can lead to flaking or cracking of the coating.

The object of the invention was therefore to overcome the disadvantages known in the state of the art, i.e. to provide a polyaniline which is readily dispersible and has a good adhesion to substrates and is also suitable for water conditioning.

### BRIEF DESCRIPTION OF THE INVENTION

The object is achieved by a polyaniline, comprising aniline units and organosulphur units, characterized in that the polyaniline is doped and has a number average degree of polymerization of approximately 5 to approximately 50.

The scope of the invention also includes a process for the preparation of polyaniline, wherein aniline and at least one organosulphur unit are converted to a polyaniline derivative in an oxidative, acid-catalyzed polymerization reaction.

A subject of the invention is also a coated substrate which is coated with the polyaniline according to the invention and also a process for coating the substrate.

The scope of the invention furthermore also includes a coating composition which is suitable for coating the substrate.

The invention thus also relates to a process for the preparation of a coating composition, wherein the process comprises the steps:
a) preparation of a ground polyaniline according to the invention,
b) optional further grinding of the polyaniline,
c) production of a dispersion from the ground polyaniline and a dispersant,
d) optional treatment of the dispersion by energy input, in particular with ultrasound, and
e) filtration.

A subject of the invention is also the use of polyaniline which is doped and contains sulphur in the polymer main chain, for water treatment, in particular water purification and/or water conditioning, and/or for the purification of air and/or for the preparation of redox flow batteries and/or in electrolysis and also a purification reactor for carrying out the purification process.

### DETAILED DESCRIPTION OF THE INVENTION

A subject of the invention is a polyaniline which comprises aniline units and organosulphur units and is characterized in that the polyaniline is doped and has a number average degree of polymerization of approximately 5 to approximately 50, preferably approximately 8 to approximately 35, particularly preferably approximately 8 to approximately 30.

Polyaniline is a conjugated polymer which consists of aniline monomers coupled together by oxidation and acid catalysis. Polyaniline can be doped (emeraldine salt, ES). In the case of an acid-catalyzed polymerization, the doping agent is the acid anion, the base form (emeraldine base, EB) is present in the basic medium. Polyaniline is also a redox-active material: emeraldine salt can change colour and accordingly its conductivity under the influence of different media or a shift of the electric potential. Non-doped polyaniline appears blue, doped polyaniline green and the reduced forms yellowish. Selective modifications can be achieved by doping by adding or removing anions with different chemical-physical properties.

The degree of oxidation and the degree of doping, the doping agent and the pH of the surrounding medium substantially determine the electrochemical and electric properties of the polyaniline, such as e.g. the state of the redox systems and the conductivity.

In the redox scheme (Scheme 1), “oxidation” and “reduction” relates to the oxidation step of the carbon of the polymer chain. When anions are attached to the nitrogen such that a polycation forms, this is called doping of the polymer. This is an acid-base reaction.

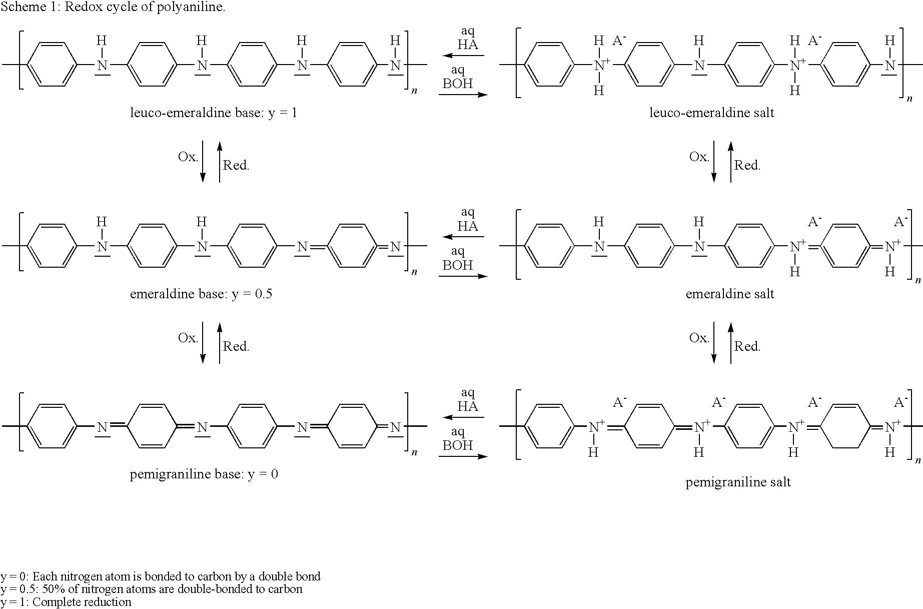

The doping can take place with any acid. Preferred acids are sulphonic acids and acids with bulky substituents. Particularly preferred is alkylbenzenesulphonic acid and in particular dodecylbenzenesulphonic acid (C₁₂-alkylbenzenesulphonic acid). In aqueous solution, the acid is preferably to have a pKₛ<5, particularly preferably <4.

The degree of doping of the polyanilines according to the invention is usually less than 50%, preferably less than 35% and in particular approximately 25%. The degree of doping can be determined according to methods known in the state of the art, for example by titration. This can be based on DIN 53402 (determination of the acid number). Determination is also possible by calculation, wherein the degree of doping results from the molar ratio of nitrogen atoms in the polyaniline main chain to the equivalents used of the doping agent.

The polyanilines according to the invention are coupled with organosulphur units. Preferred organosulphur units are thiols, wherein in general all thiols known in the state of the art can be used.

The thiolpolyanilines according to the invention can be represented by the formula PAni-S—R.

PAni stands for polyaniline and

R is alkyl, aryl, alkylaryl, alkyl(aryl)₂, alkyl(aryl)₃, arylalkyl, alkyl-C(═O)—O-alkyl, alkyl-CO₂H, alkylferrocenyl, arylferrocenyl, ferrocenyl, allyl, alkyl-X-alkyl, alkyl-X-aryl, aryl-X-aryl, aryl-X-alkyl or C₃₋₁₂ cycloalkyl,

wherein X is —O—, —S— or —NH—,

wherein each of the abovenamed alkyl radicals independently of one another contains 1 to 20 carbon atoms, preferably 1 to 15 and in particular 1 to 12 carbon atoms, can be straight-chained or branched and optionally can be substituted one or more times by —SO₃H, —SO₃⁻ alkali cation (in particular —SO₃⁻Na⁺), —CO₂H, -halogen (in particular F, Cl or Br), -hydroxy, -amino, -amino-C₁₋₂₀ alkyl, -amino(C₁₋₂₀ alkyl)₂, —CO₂—C₁₋₂₀-alkyl, —C₁₋₂₀ alkyl, —NH—CO—C₁₋₂₀-alkyl, —Si(C₁₋₃ alkyl)₃ and wherein each of the abovenamed aryl radicals independently of each other can be phenyl or naphthyl which can both be substituted one or more times by —SO₃H, —SO₃⁻ alkali cation (in particular —SO₃⁻Na⁺), —C₁₋₂₀ alkyl, in particular methyl or t-butyl, halogen (in particular F, CI or Br), —NO₂, —OH, —NH₂, —NHC₁₋₂₀-alkyl, —N(C₁₋₂₀ alkyl)₂, —CF₃, —CO₂H, —CO₂—C₁₋₂₀-alkyl, —NH-tert-butoxycarbonyl, —C₁₋₂₀ alkyl-OH, —O—C₁₋₂₀ alkyl, —S—C₁₋₂₀ alkyl, —C₁₋₂₀-alkyl-CO₂H or —NH—CO—C₁₋₂₀-alkyl.

The sulphonic acid salt —SO₃⁻ alkali cation, in particular —SO₃⁻Na⁺, is a preferred substituent for both alkyl and aryl radicals, as the alkali cation, in particular sodium cation, can be replaced by H⁺ and the thiolpolyanilines according to the invention can dope themselves by means of their own acid group (see also below).

There can be named by way of example as radical S—R alkylthiols with 1 to 16 carbon atoms or thiobenzene and thionaphthaline. Dodecanethiol is particularly preferred.

It is preferred that the organosulphur units, for example the named thiols, are connected via their sulphur atom to the terminal end, preferably to the aromatic terminal end, of the polyaniline chain.

Both the unsubstituted aniline and also substituted aniline or combinations thereof can be used as aniline monomer. The aniline derivatives can carry e.g. substituents with hydrocarbon radicals, e.g. 2-methyl-aniline, aniline-2-sulphonic acid, aniline-3-sulphonic acid or similar compounds. These copolymerisates display modified properties e.g. in redox and solubility behaviour.

Surprisingly, the novel polyanilines are characterized by a small molecule chain length. The reason for this is to be found in the preparation process of the novel polyanilines, wherein aniline and at least one organosulphur unit are converted to a polyaniline derivative in an oxidative, acid-catalyzed polymerization reaction. Without being tied to this theory, the organosulphur unit supposedly acts as a molecular mass regulator through chain termination. Because of the relatively small degree of polymerization and the concomitant short molecule chain lengths, the polyanilines according to the invention can be dispersed relatively easily, wherein a very fine and homogeneous dispersion forms which is very suitable as a coating composition. Substrates coated with such a coating composition display a move even coating with a smaller proportion of coarse-grained constituents, for example agglomerates, as a result of which such a coating on a substrate is consequently stable over a longer period. Crack formation and flaking of whole coating parts can thus be prevented to a significant extent and the catalytic function of the coated substrate maintained.

The degree of polymerization of the polyanilines can be determined with conventional measurement methods (gel permeation chromatography, GPC), but an exact measurement requires a polyaniline standard. The degree of polymerization is therefore preferably measured via the molecular mass by MALDI-TOF, wherein this is a so-called absolute method and delivers a relatively exact result.

The degree of polymerization can also be easily measured via the N/S atomic ratio. The polyaniline preferably has an N/S atomic ratio of 5:1 to 50:1, more preferably 8:1 to 35:1 and particularly preferably 8:1 to 30:1, in the polyaniline main chain. The N/S atomic ratio relates exclusively to the nitrogen and sulphur atoms in the polyaniline main chain, i.e. the backbone of the polymer, so that when the atomic ratio is considered nitrogen and/or sulphur atoms possibly located in the side chain are disregarded. In this context, for example sulphonic acid groups could be named which can be encountered in the side chain due to the self-doping and adjustment of the solubility of the polyaniline depending on the synthesis route.

The N/S atomic ratio can be measured according to the methods known in the state of the art, in particular via a CHNS elemental analysis. Possible nitrogen and sulphur atoms in the side chain of the polyaniline (e.g. sulphonic acids) are also detected in a CHNS elemental analysis and must therefore be disregarded when taking account of further parameters, such as for example the ratio of educts used, measurement values from the MALDI-TOF mass spectrometry and possibly relevant analytical data such as FT-IR, Raman and NMR data.

It is also preferred within the meaning of this invention that the polyaniline comprises an acid group. As already stated above, such acid groups are usually to be found in the side chain, are thus for example attached to the aromatic of the aniline, wherein self-doping polyanilines are obtained by the acid group. Therefore, in PAni synthesis, aniline-2-sulphonic acid or aniline-3-sulphonic acid are preferably used as comonomer in addition to aniline. Thus the addition of an acid is no longer required for doping. Self-doping polyanilines are already known in the state of the art and can be prepared for example by sulphonation of polyaniline (J. Yue, A. J. Epstein, J. Am. Chem. Soc., 1990, 112, 2800 to 2801) or by copolymerization of aniline with aniline-3-sulphonic acid (Junhua Fan, Meixiang Wan, Daoben Zhu, Institute of Chemistry, Academia Sinica, Beijing 100080, China, 1997). As a result of the doping, the polyaniline is electrochemically stabilized and the redox behaviour is much less pH-dependent than that of customary polyaniline. It is to be borne in mind however that the electric conductivity of doped polyanilines decreases as the degree of substitution increases.

An embodiment is particularly preferred in which an aliphatic thiol is attached to the aromatic terminal end of the polyaniline main chain, the polyaniline has a number average degree of polymerization of approximately 5 to approximately 30 and sulphonic acid groups on the aniline units.

The polyanilines according to the invention are prepared by a process wherein aniline and at least one organosulphur unit are converted to a polyaniline derivative in an oxidative, acid-catalyzed polymerization reaction. The polymerization process is particularly preferably a precipitation polymerization. In the case of the process according to the invention it is preferred if an organosulphur unit, as already defined above, is used. The polymerization is therefore preferably carried out in the presence of a thiol H—S—R, wherein R is defined as above for PAni-S—R. Dodecanethiol (DCT) is particularly preferred. In principle, any acid can be used as acid for the acid-catalyzed conversion. The acid is preferably to have a pKₛ<5, particularly preferably <4. The oxidative acid-catalyzed polymerization reaction process furthermore requires an oxidizing agent, wherein oxidizing agents known in the state of the art can be used. There may be named by way of example hydrogen peroxide, potassium peroxodisulphate, ammonium peroxodisulphate, potassium permanganate and similar. An electrochemical polymerization is also possible instead of using an oxidizing agent.

Substrates which can be coated with the polyaniline according to the invention are for example an electrode, a packed bed, a membrane, a fleece and/or a nonwoven fabric, a woven fabric, an interlaced fabric, a knitted fabric, a gauze, a flat membrane, a hollow fibre membrane, a capillary, a hollow capsule or also combinations of the aforenamed, wherein all these substrates can be conductive or non-conductive. Preferred substrates are graphite and carbon fibre woven fabrics and also high-grade steel. Further preferred is for example a combination of a membrane as cathode, for example a hollow fibre membrane as cathode. Preferred supporting agents are organic polymers, polymer compositions, inorganic materials or composite materials. The advantage of the polyanilines according to the invention is that, unlike the state of the art, they can be applied to conductive and non-conductive substrates.

Separations with membranes are increasingly becoming key technologies in water conditioning. The separating function and separating capacity of the membrane is determined by the structure of the barrier layer: the water desalination or the separation of low-molecular substances by reverse osmosis or nanofiltration based on membranes with pore-free barrier layers, while membranes with porous separating layers are used for the separation of macromolecules or colloidal substances by ultra- or microfiltration. Typical microfiltration membranes have pores with a separating effect in the region between 0.1 and 1 μm; compared with conventional filter materials these pores are smaller and the inner surfaces are much larger. Membranes that can be used according to the invention can be classified as follows:
Membrane material: organic polymers, inorganic materials (oxides, ceramics, metals), composite materials from different materials;
Membrane cross-section: isotropic (“symmetric”), integrally anisotropic (“asymmetric”), double- or multi-layered, thin-layered or “mixed matrix” composite;
Preparation process: phase separation (“phase inversion”) of polymers, sol-gel process, thermodegradation, interface reaction, stretching, extrusion, nuclear track technique, microfabrication;
Membrane form: flat membrane, hollow fibre or capillaries, hollow capsule.

By far the most commercial microfiltration membranes are composed of organic polymers such as e.g. non-conductive polysulphone or non-conductive polypropylene. The pore size distribution over the membrane cross-section is either isotropic or slightly anisotropic. Among the preparation processes, variants of the phase separation of polymer solutions clearly dominate, preferably induced by a precipitant (“non-solvent induced phase separation”, NIPS) or by cooling in an unstable area (“temperature-induced phase separation”, TIPS). Not every polymer can be processed with every process: polysulphone is typically shaped into porous membranes by NIPS, polypropylene typically by TIPS. For MF applications, both flat membranes (in spiral winding modules or plate modules) and capillary membranes are customary.

As already mentioned in the introductory section, a problem with coated substrates for water conditioning, for example in the case of membranes, is that they are subject to so-called scaling and fouling. This is usually associated with the fact that deposits settle on the surface of the coating.

Through the ability of polyaniline to produce active oxygen species, such as OH radicals or also other radicals, a polyaniline which is doped and contains sulphur in the polyaniline chain is thus suitable for water conditioning and/or for the purification of air and can thus be used for these purposes. A polyaniline as described above can preferably be used for water conditioning and/or for the purification of air. The water conditioning and/or the purification of air includes the removal of organic and inorganic pollutants, bacteria, viruses, microorganisms and/or parasites, i.e. both a purification and to a certain degree a sterilization/disinfection of the water or air. This takes place, as already mentioned above, through the production of active oxygen species such as OH radicals which have a deactivating effect for example on bacteria, viruses, microorganisms and/or parasites. Organic or inorganic pollutants can be oxidized for example by the OH radicals and thus made harmless.

It was further established that the anilines according to the invention can also advantageously be used in redox flow batteries and in electrolysis systems.

Consequently, a coating composition is also required for the preparation of a coated substrate, for which reason a process for the preparation of a coating composition likewise belongs to the scope of the invention, wherein the process comprises the steps:
a) provision of a polyaniline which is preferably ground and therefore as homogeneous as possible within the meaning of a uniform particle size,
b) optional homogenization of the polyaniline,
c) production of a dispersion from the optionally homogenized polyaniline and a dispersant,
d) optional treatment of the dispersion by energy input, in particular with ultrasound,
e) filtration.

Like all ICPs, polyaniline is usually not soluble and has no melting point or other softening behaviour. For this reason, polyaniline cannot be processed like customary thermoplastic polymers. A processing is therefore carried out via ultrafine distribution (dispersion) in solvents or dispersants. Polyaniline dispersions are therefore the starting point for many applications.

To be able to process polyaniline, the polyaniline is dispersed in solvents in powder form. The starting point for further processing are the thus-prepared polyaniline dispersions. Coatings can be prepared from such dispersions. It has been shown that, the smaller the particles and the more homogeneous the distribution of the polyaniline in the dispersant, the better the adhesion of the layers to a substrate. The quality of the layer is determined by the particle size and type of the solvent/dispersant or the composition of the solvent/dispersant mixture.

The following steps are advantageous in the order shown for obtaining the dispersion from the raw polymerisate:

1. synthesis (raw polymer)
2. washing
3. ion exchange
4. drying
5. dispersion
6. filtration
7. doping

The aim when synthesizing polyaniline is to prepare the polymerisate in a quality which guarantee a further processing which is as problem-free as possible and the best possible dispersability.

Under unfavourable processing conditions, agglomerates in μm size are formed. This can be due to unfavourable polymerization conditions or be attributable to the choice of solvent or dispersant or to the dispersion method.

In principle, the aim is to prepare a dispersion that is as homogeneous as possible with particle sizes <1 μm. The particle size can be measured according to a standard method, “dynamic laser light scattering”. The advantages in the preparation and processing of such a dispersion follow from:
a good filterability (short filtration time, small number of filtration steps)
a small filtration residue
a good adhesion to the support

It must furthermore be ensured that the dispersion wets the substrate to be coated.

The grinding, i.e. homogenization, of the polyaniline is preferably to take place in an alcohol, particularly preferably propanol. N-methylpyrrolidone (NMP) has proved a particularly suitable dispersant. However, other dispersants known in the state of the art are also suitable.

As already described above, the polyaniline is to be doped. It has proved particularly advantageous if the polyaniline is redoped with alkylbenzenesulphonic acid after step e.) of the process according to the invention, the filtration. Dodecylbenzenesulphonic acid (DBS) is particularly preferred. It can be advantageous to subject the coating composition to a further energy input, in particular a further ultrasound treatment, after doping. Possible agglomerates formed during doping can be redispersed again. The degree of doping can be adjusted exactly by the redoping. Otherwise, this is possible only with difficulty in the case of doping which is present directly after synthesis. As a result of the exact adjustment of the degree of doping, the conductivity of the polyaniline can thus also be adapted to the necessary conditions.

The coating of a substrate with a coating composition according to the invention is usually carried out by applying the coating composition to the substrate according to methods known in the state of the art and then drying the coating. Possible application methods are for example dipping, coating with a doctor knife, spraying, gravure printing, coating and peeling off, reverse-roll coating and spin coating, spreading on or brushing on with a roller and similar.

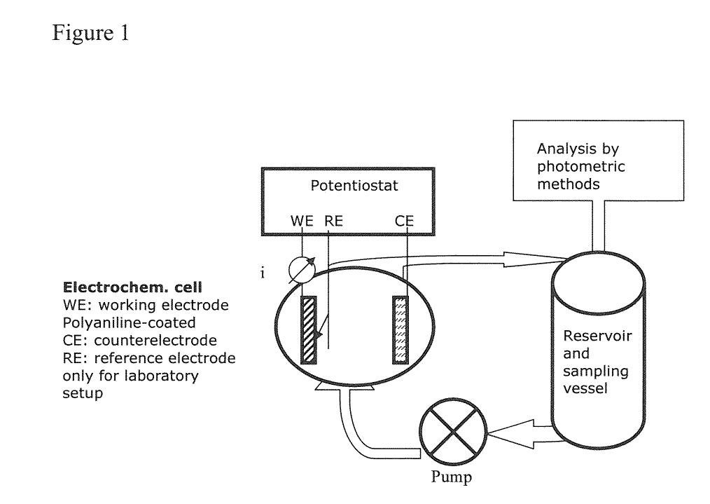

Such a coated substrate, for example a coated membrane, can be used in a purification reactor to condition water and/or to purify air. Thus the scope of the invention also includes a purification reactor, wherein the reactor comprises a reaction chamber with inlet and outlet for the medium to be purified, at least one, in particular one, two, three or more coated substrates according to the invention, at least one, in particular one, two, three or more counterelectrodes, and optionally at least one, in particular one, two, three or more separators between the coated substrate(s) and the anode(s). A laboratory set-up according to the invention can be seen for example in FIG. 1, wherein the reference electrode is required only for the laboratory set-up.

For the counterelectrode(s), low-cost materials such as high-grade steel can be used as support material and current collector. The electrodes can be designed as flat plates, perforated plates, wires, packed beds or stretched metals. Carbon fleeces can also be used.

The electrochemically active substance on the working electrode(s) is the polyaniline derivative. The direct synthesis on the electrodes comprised of monomers is industrially attractive. In addition, it is ensured during the development of the process to deposit coatings of the already synthesized polymer on the electrodes. Established thick-film coating methods are known for this in which the polyaniline film is poured directly onto metal foils optionally with one or more intermediate layers of a conductive adhesion promoter. The coated foils can then act as plate, stretched or in filament form as working electrodes. The combination of the polyaniline with hollow fibre membranes is particularly attractive. The polyaniline can be present as a layer or doping on or in the polymer.

The distance between anode and cathode necessary to avoid short circuits can be created by separators, diaphragms or spacers. Hydrophilic nonwoven fleeces or woven fabrics, such as e.g. from PPS, are suitable. They are used industrially as supporting membranes in reverse osmosis. It is also possible to equip assembled electrodes with separator membranes by reprecipitation.

Potentiostatic operation with a three-electrode arrangement has been used on a laboratory scale for process development. The electrochemical parameters can be determined by means of cyclic voltammetry. The potential of a saturated calomel electrode is used as reference. This reference electrode is separated from the water (or air) to be treated by a diaphragm. In reality on an industrial scale diaphragms tend to become clogged by crystallization or seeding with microbes. In practice on an industrial scale, a switch from potentiostatic to galvanostatic operation is therefore conceivable. The control circuits are thereby simplified, but greater importance is to be attached to the homogeneous distribution of the electric fields in the design of the reactor.

FIG. 1 outlines the principle of the laboratory set-up. At its center is an electrochemical cell with replaceable electrodes. These enable different coatings and support materials to be used.

The electrodes are controlled by a potentiostat which carries out a corresponding polarization of the electrodes. As a result, basic electrochemical tests, such as the determination of the optimum work potential, are made possible. The water to be treated is recycled by means of a pump via a reservoir. Samples can be taken in this. The apparatus makes it possible to operate both in recycle and passage mode.

Photometric measurement methods are usually used as analytical method. To quantify the efficiency of electrodes and reactor, the selective method of bleaching the dye RNO (=p-nitrosodimethylaniline) is used. This dye is described as a selective OH radical scavenger in Kraljic, C. N. Trumbore, p-Nitrosodimethylanilin as a Radical Scavenger in Radiation Chemistry, Journal of the American Chemical Society, 87:12 (1965), 2547-2550 and can therefore serve as an indicator of the generated OH radicals.

In a purification reactor according to the invention, polyaniline can be used as a coating or constituent of
planar electrodes,
3-D metallic lattice structures,
membrane structures,
flat membranes,
hollow fibre membranes, or
fixed-bed packings.

The invention is now explained in more detail using some non-limiting examples with reference to the figures.

### EXAMPLES

### Example 1

### Synthesis of Polyaniline Dodecanethiol

### (Poly(p-phenylene-amine-imine)-p-dodecanethiol)

The thiol derivative of the polyaniline is prepared in an oxidative, acid-catalyzed precipitation polymerization in aqueous solution. The aniline is polymerized together with dodecanethiol (DCT). The polymerization chain reaction is accordingly interrupted with the attachment of the thiol radical to the polyaniline radical.

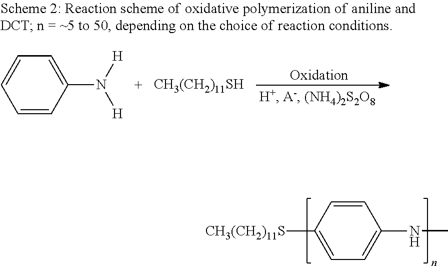

The chemicals required for the synthesis are listed in Table 1 below.

TABLE 1
Substances for the polyaniline synthesis

| | | Molecular | |
|---|---|---|---|
| | | weight | Quantity used |
| Name | Formula | (g/mol) | (g; mol) |
| Aniline | C₆H₄NH₂ 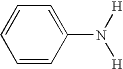 | 93 | 3 ml (33 mmol) |
| Ammonium | (NH₄)₂S₂O₈ | 228.2 | 11 g |
| peroxodisulphate | | | (48 mmol) |
| Toluene-4- sulphonic acid monohydrate (p- TSA) | 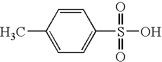 | 190.22 | 34 g (179 mmol) |
| Dodecanethiol | CH₃(CH₂)₁₁SH | 202.40 | 0.35 ml |
| | | | (1.5 mmol) |

### Description of the Synthesis:

1) 3 ml (33 mmol) aniline and 0.35 ml (1.5 mmol) dodecanethiol are placed one after the other in a glass beaker. The mixture is thoroughly blended.
2) 34 g (179 mmol) p-toluenesulphonic acid p-TSA are placed in a 0.3-l beaker and made up to 0.2 l with water. The solution is cooled to 0° C.
3) The aniline/dodecanethiol mixture is added under stirring within 20 minutes to the p-TSA solution prepared in 2).
4) The oxidant solution is prepared as follows: 11 g (48 mmol) ammonium peroxodisulphate (APS) is weighed in and then made up to 30 ml with deionized water. The solution is transferred to a dropping funnel.
5) The monomer mixture prepared in point 3 is transferred into a three-necked flask and stirred vigorously. The reaction mixture is cooled to 0° C. in a cold bath.
6) The polymerization is started by slow addition (1 ml/min) of the oxidation mixture to the emulsion presented in the reactor comprising aniline, dodecanethiol and p-TSA.
7) After all the oxidant has been added, the reaction mixture continues to react for approximately 5 hours.
8) The polymer is then washed as follows:
1st step: filtration, pour in 0.3 l deionized water
2nd step: redispersion of the filter cake in 1 l 1 M NH₄OH
3rd step: filtration
4th step: redispersion e.g. in methanol
5th step: filtration
6th step: rinsing with 1 l deionized water.

The filter cake is transferred into a beaker after washing and dried to constant weight in a vacuum oven.

Yield: The yield is approx. 90 to 95% relative to the quantities of aniline used.

### Analysis/Light Microscopy (Particle Sizes)

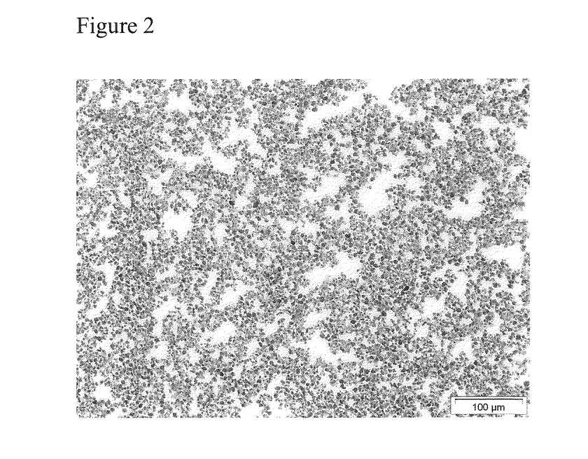

FIG. 2 shows polyaniline DCT, directly after synthesis, enlarged 100 times. The polymerization product is present as loosely agglomerated particles; larger agglomerates (1-10 μm) are readily recognizable which degrade into finer particles (<1 μm) when the microscope slide is moved mechanically.

### Analysis/Identification by Means of FT-IR

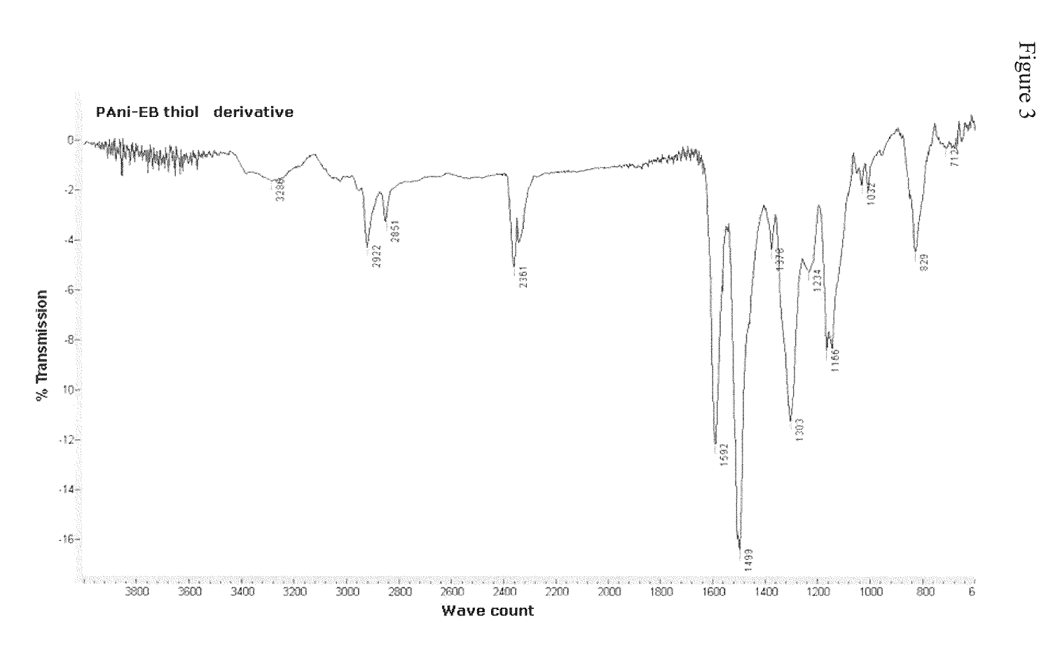

FIG. 3 shows an IR spectrum of the polyaniline-DCT base. The labelled areas identify the DCT component in the polyaniline.

### Analysis/Identification by Means of Elemental Analysis (CHNS)

(Pre-treatment: Ion exchange with NH₄OH, followed by repeated washing with 2-propanol, methanol and xylene)

TABLE 2
The base form was analyzed. The elemental analysis gives an N/S ratio
of approximately 22:1.

| | Measured |
|---|---|
| Element | % proportion |
| C | 70 |
| H | 6.385 |
| N | 11.96 |
| S | 1.275 |

### Example 2

### Dispersion of Polyaniline

The starting material for dispersions is the powder of the non-conductive base form of polyaniline (EB).

1) Preparation of 2.5-% (w/v) PAni-EB-NMP Stock Dispersion

2.8 g pulverant polyaniline in base form (EB) is comminuted by means of a mortar for a period of approx. 5 minutes. 5 ml 2-propanol is added to the powder. The mixture is slurried with the mortar for approximately 5 minutes. The slurry is then transferred into a beaker in which 100 ml N-methyl-2-pyrrolidone (NMP) are presented. The mixture is then dispersed with a homogenizer at 10000 rpm. The dispersion is then heated to 50° C. and stirred for several hours on the magnetic stirrer. The thus-treated dispersion is filtered through cellulose filters in order to remove any agglomerates that are present.

The dispersion prepared in step 1 is called PAni-EB-NMP 2.5% (w/v) stock dispersion below.

2) Preparation of 2-% (w/v) PAni-ES(DBS)—NMP Stock Dispersion

The dispersion prepared in 1) is redoped with dodecylbenzenesulphonic acid (DBS). 1-6 g DBS is added to 40 ml of the EB-NMP stock dispersion.

The mixture is homogenized for at least 30 minutes at 50° C. in the ultrasound bath and filtered through a cellulose filter to remove agglomerates that may have formed during preparation.

This dispersion is called PAni-ES-DBS-NMP 2% (w/v) stock dispersion

The dispersion prepared under 2) can be diluted as required with further solvents or solvent mixtures to adjust the concentration, the flow or wetting properties and is then ready for coating or for incorporation into other substances.

### Example 3

### Preparation Example, Coating of Sheet Steel

### Materials:

ES dispersion 1% (w/v)
Steel foil
Doctor coater
Doctor knife

A purified and degreased foil section is placed on the flat bearing surface over which a doctor blade is drawn. The doctor knife has a width (inside) of 73 mm; this width determines the width of the coating on the sheet steel. The gap width between substrate and doctor knife is 50 μm. The doctor knife is placed on the substrate behind the slider. 1 ml 1% (w/v) dispersion is placed on the inside of the doctor blade. The doctor knife is then drawn over the steel foil at a constant drawing speed of 20 mm/s, and a thin film of the coating dispersion remains on the substrate. The solvent is evaporated off with a hot-air hairdrier at 200° C. (setting on the drier). After evaporation of the solvent, the remaining solvent residues are evaporated in the vacuum drying cupboard at 120° C. A greenly shimmering polyaniline layer with a thickness of approx. 200-1000 nm is obtained.

### Example 4

### Membrane Preparation

Two different ways of preparing catalytically active membranes in which the following functions are combined with each other are described below by means of examples:
i) permeable pore structure with moderate contact surface (specific, inner surface between 10 and 25 m²/g),
ii) sufficient conductivity for electric bonding/controlling of the catalytically active material,
iii) Layer or doping of catalytically active material (PANi).

### Example 4.1

### Metalation of a Commercial MF Membrane and Subsequent Coating with PAni

A microfiltration membrane of polypropylene (flat membrane 2EHF, Membrana GmbH) with a nominal pore size (separation limit) of 0.4 μm and also a specific surface of 25 m²/g is incorporated into a Teflon filter holder (diameter 47 mm) and washed through with the following solutions (each 1 ml/min) with the help of a hose pump:
chromo-sulphuric acid (50° C.) for 5 min.
ultrapure water (25° C.) for 15 min.
solution of 10 vol-% PDI 11 activator concentrate (Schlötter Galvanotechnik GmbH & Co KG, Geislingen) and 0.1 vol-% SLOTOSIT N 16 wetting agent (Schlötter) in ultrapure water (25° C.) for 3 min.
ultrapure water (25° C.) for 15 min.
solution of 4.5 ml SLOTONIP 61 (Schlötter), 3.5 ml SNI supplementary solution (Schlötter), 25 μl SLOTONIP 63 wetting agent (Schlötter), 25 μl SLOTONIP 64 stabilizer (Schlötter), and 1.5 ml SLOTONIP 66 reducing agent (Schlötter), made up with 25 ml water (25° C.), for 20 min.
ultrapure water (25° C.) for 15 min.
SLOTOGOLD 10 gold dipping bath (Schlötter; 80° C.) for 5 min.
ultrapure water (25° C.) for 15 min.

The membrane is then dried in the vacuum drying cupboard at 45° C. The characterization is carried out with REM, nitrogen adsorption (BET), permporometry and measurements of the water permeability.

3 ml of the PAni dispersion according to Example 2 are then sucked through the membrane in the filter holder with the help of a pump within 3 min, then air is sucked through the membrane for a further 5 min. This is followed by drying at 45° C. in the vacuum drying cupboard. The characterization is carried out with REM, nitrogen adsorption (BET), permporometry and measurements of the water permeability.

### Example 4.2

### Preparation of a Porous Membrane Doped with Carbon Black and PAni by Precipitation-Agent-Induced Phase Separation

A solution of 12 wt.-% polyethersulphone in a mixture of NMP and triethylene glycol (ratio 2:1, v/v) is prepared (approx. 3 h stirring at 45° C.). 6 wt.-% carbon black and 10 wt.-% of a 2-% PAni dispersion, each relative to the overall solution, is then added to it. After 10 min dispersion in an ultrasound bath the solution is stirred for a further 1 h at 45° C. A 250-μm-thick film of the polymer solution is then produced on a polished glass plate with the help of a doctor knife. After a residence time of 30 sec at 25° C. and approx. 40% air humidity the precipitation takes place in a bath of ultrapure water containing 25 vol-% NMP. After a residence time of 1 h in the precipitation bath the membrane is transferred into a washing bath of ultrapure water which is changed twice more at intervals of ˜0.4 or ˜16 hours each time. The thus-produced membrane is then treated by solvent exchange (water→ethanol) and then dried. The layer thickness of the membrane is approximately 200 μm.

The characterization is carried out with REM, nitrogen adsorption (BET), permporometry and measurements of the water permeability.

### Example 5

### OH Radical Production, RNO Degradation

PAni is applied by the dipping method to a commercially available fleece of graphite fibres. The electrode was mounted in a gap reactor and potentiostatically operated.

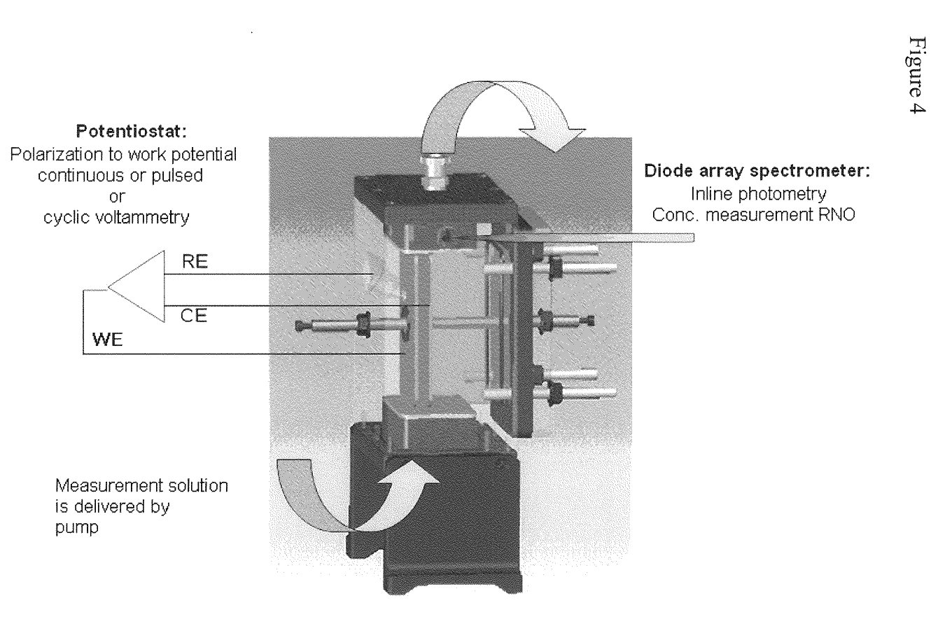

FIG. 4 shows a laboratory reactor for producing OH radicals:
Starting solution: 10⁻⁵ mol/l RNO solution
   0.5 g/l Na₂SO₄
   H₂O
Working electrode (WE): HICOTEC NE 0300 GDL graphite fleece, Frenzelit, stamped, washed in H₂O, then in acetone, drying 15 min at 110° C.,
   PAni dispersion: doping agent DBS, purified fleece, dipped.
   The sample is dried overnight at 110° C.
   Projected surface of the working electrode=5×8 cm.

| | Sample 1 |
|---|---|
| Mass of support material | 90.89 mg |
| Coating | PANI-DBS |
| Mass with layer after | 110.63 mg |
| drying | |
| Mass of layer | 19.65 mg |

Counterelectrode (CE): High-grade steel electrode 1.4301, surface as working electrode
Reference electrode: Saturated calomel electrode
Distance WE/CE: 2 mm, test for any short circuits with multimeter
Measurement method photometer: RNO 10⁻⁵ molar differential measurement of the extinctions at 438 nm and 540 nm
Pumping rate: 38 ml/min

To demonstrate the reproducible effect, in the present experiment the working electrode is polarized for 2 min (120 s) in each case to −700 mV against saturated calomel electrode and the RNO concentration is tracked by means of an inline photometer. Because of the residence time effects between electrocatalytic chamber and photometer probe, the RNO signals are shifted by approx. 1 min.

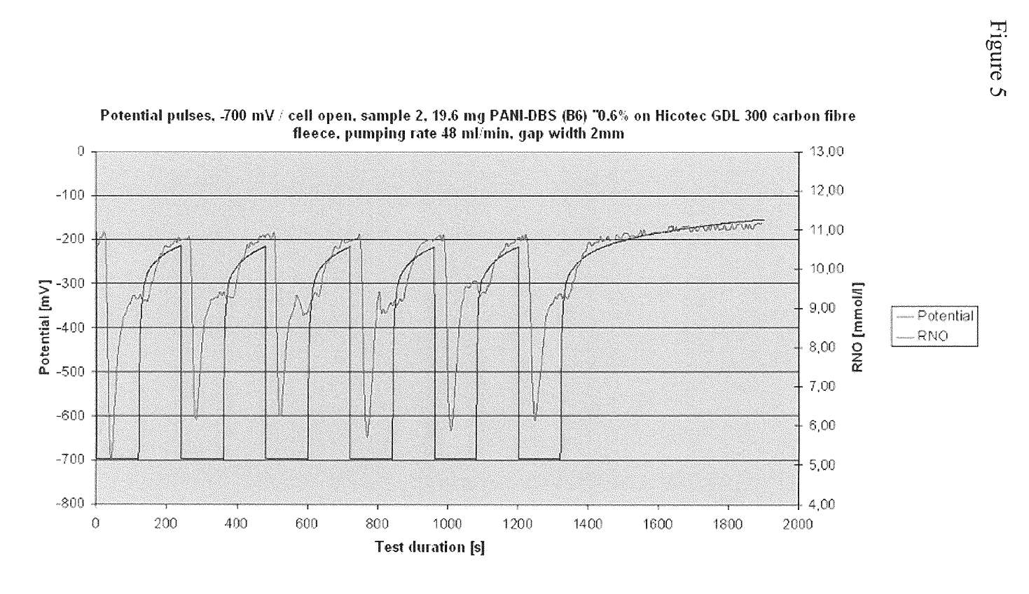

FIG. 5 shows the RNO concentration in the degradation test with pulsed polarization of the polyaniline working electrode. The absorption signal at 438 nm pulses parallel and reproducible with the applied polarization.

1. Polyaniline, comprising aniline units and organosulphur units, characterized in that the organosulphur units are thiols and the polyaniline is doped and has a number average degree of polymerization of approximately 5 to approximately 50, wherein
the polyaniline is represented by the formula PAni-S—R, wherein PAni stands for polyaniline, and wherein
R is selected from the group consisting of alkyl, aryl, alkylaryl, alkyl(aryl)₂, alkyl(aryl)₃, arylalkyl, alkyl-C(═O)—O-alkyl, alkyl-CO₂H, alkylferrocenyl, arylferrocenyl, ferrocenyl, allyl, alkyl-X-alkyl, alkyl-X-aryl, aryl-X-aryl, aryl-X-alkyl and C₃₋₁₂ cycloalkyl,
wherein X is selected from the group consisting of —O—, —S— and —NH—,
wherein each of the abovenamed alkyl radicals independently of one another contains 1 to 20 carbon atoms, can be straight-chained or branched and optionally can be substituted one or more times by a substituent selected from —SO₃H, —SO₃⁻ alkali cation, —CO₂H, -halogen, -hydroxy, -amino, -amino-C₁₋₂₀ alkyl, -amino (C₁₋₂₀ alkyl)₂, —CO₂—C₁₋₂₀-alkyl, —C₁₋₂₀ alkyl, —NH—CO—C₁₋₂₀-alkyl, —Si (C₁₋₃ alkyl)₃, and wherein each of the abovenamed aryl radicals independently of each other can be phenyl or naphthyl which can both be substituted one or more times by a substituent selected from —SO₃H, —SO₃⁻ alkali cation, —C₁₋₂₀ alkyl, halogen, —NO₂,
—NHC₁₋₂₀-alkyl, —N(C₁₋₂₀ alkyl)₂, —CF₃, —CO₂H, —CO₂—C₁₋₂₀—alkyl, —NH-tert-butoxycarbonyl, —C₁₋₂₀ alkyl-OH, —O—C₁₋₂₀ alkyl, —S—C₁₋₂₀ alkyl, —C₁₋₂₀-alkyl-CO₂H and —NH—CO—C₁₋₂₀—alkyl.

2. (canceled)

3. (canceled)

4. Polyaniline according to claim 1, characterized in that the polyaniline comprises an acid group.

5. Process for the preparation of the polyaniline of claim 1 comprising converting the aniline and at least one organosulphur unit to a polyaniline derivative in an oxidative, acid-catalyzed polymerization reaction.

6. Process for the preparation of a coating composition, wherein the process comprises the steps:
a) providing the polyaniline according to claim 1,
b) homoganizing the polyaniline,
c) producing a dispersion from the homogenized polyaniline and a dispersant,
d) treating the dispersion by energy input, and
e) filtering the dispersion.

7. Process according to claim 6, characterized in that the homogenization of the polyaniline is provided in a solvent which is not the same as the dispersant and is preferably an alcohol.

8. Process according to claim 6, characterized in that the dispersant is NMP.

9. Process according to claim 6, characterized in that after step e), the polyaniline is doped with an acid.

10. Process according to claim 9, characterized in that the acid comprises a C₁₂ alkylbenzenesulphonic acid.

11. A coating composition obtainable according to the process of claim 6.

12. A coated substrate, characterized in that a substrate is coated with the coating composition containing polyaniline prepared by the process of claim 6.

13. Coated substrate according to claim 12, characterized in that the substrate is selected from the group consisting of an electrode, a packed bed, a membrane, a fleece and/or a nonwoven fabric, a woven fabric, an interlaced fabric, a knitted fabric, a gauze, a flat membrane, a hollow fibre membrane, a capillary, a hollow capsule, and combinations thereof.

14. Coated substrate according to claim 12, characterized in that the substrate is selected from the group consisting of an organic polymer, a polymer composition, an inorganic material and a composite material and can be conductive or non-conductive.

15. Process for the preparation of the coated substrate according to claim 12, characterized in that the coating composition is applied to a substrate and optionally dried.

16. (canceled)

17. (canceled)

18. (canceled)

19. (canceled)

20. (canceled)

21. (canceled)

22. Purification reactor, characterized in that the reactor comprises
a reaction chamber with inlet and outlet for a medium to be purified,
at least one coated substrate of claim 12 as a working electrode, and
at least one counterelectrode, and
optionally at least one separator between the at least one coated substrate and the at least one counterelectrode.

23. (canceled)

24. Purification of a medium, such as air or water, comprising contacting the medium with the coated substrate of claim 12.

25. Process for the preparation of a coating composition, wherein the process comprises the steps:
a) providing the polyaniline according to claim 1,
b) producing a dispersion from the polyaniline and a dispersant,
c) treating the dispersion by energy input, and
d) filtering the dispersion.

26. Process for the preparation of a coating composition, wherein the process comprises the steps:
a) providing the polyaniline according to claim 1,
b) homoganizing the polyaniline,
c) producing a dispersion from the homogenized polyaniline and a dispersant, and
d) filtering the dispersion.

27. Process for the preparation of a coating composition, wherein the process comprises the steps:
a) providing the polyaniline according to claim 1,
b) producing a dispersion from the polyaniline and a dispersant, and
c) filtering the dispersion.
